(19) United States
(12) Patent Application Publication
(10) Pub. No.: US 2013/0126254 A1
(43) Pub. Date: May 23, 2013

(54) MOTOR VEHICLE

(71) Applicants: Jae Boum Lee, Siheung-si (KR); Hye Min Park, Seoul (KR)

(72) Inventors: Jae Boum Lee, Siheung-si (KR); Hye Min Park, Seoul (KR)

(73) Assignee: V-ENS CO., LTD., Incheon (KR)

(21) Appl. No.: 13/505,386

(22) PCT Filed: Nov. 1, 2010
(86) PCT No.: PCT/KR2010/007575

§ 371 Date: May 29, 2012

(30) Foreign Application Priority Data
Nov. 3, 2009 (KR) 10-2009-0105595
Apr. 15, 2010 (KR) 10-2010-0034911
Apr. 15, 2010 (KR) 10-2010-0034915

(51) Int. Cl. B60R 16/04; B62D 25/20

(52) U.S. Cl. CPC B60R 16/04; B62D 25/20
USPC 180/68.5

(57) ABSTRACT

The present invention relates to a motor vehicle in which a battery is efficiently mounted. The motor vehicle according to one embodiment of the present invention comprises: a battery module for supplying electric current; a tunnel inserted upwardly into a vehicle body so as to accommodate the battery module therein; a front floor coupled to both sides of the tunnel so as to form a front bottom of the vehicle body; and a battery carrier coupled to both edges of the tunnel so as to support the battery module.

### TECHNICAL FIELD

The present invention relates to a motor vehicle, and more particularly, to a motor vehicle in which a battery is mounted in an efficient manner.

### BACKGROUND ART

A motor vehicle is a transportation means that generates power using an engine thereof and transmits the power to wheels to transport passengers or freight on the road. The motor vehicle may be broadly divided into a vehicle body defining the external appearance of the motor vehicle, and a chassis to which a variety of devices is intimately connected. The chassis is provided with, for example, a power transmission device, a steering device, a suspension device, a braking device as well as a vehicle engine that provides driving force for vehicle traveling.

The engine provides driving force for vehicle traveling. A four-stroke internal combustion engine is the most general example of a reciprocating engine, a cycle of which consists of four strokes including intake, compression, power, and exhaust. An internal combustion engine, which mainly uses volatile fuel, obtains kinetic energy directly from thermal energy that is generated when fuel, which is well mixed with oxygen in the air for complete combustion, is burned in a compressed state.

The internal combustion engine using volatile fuel, however, causes environmental pollution due to exhaust gas and depletion of oil. Accordingly, an electric vehicle, which is driven using electric power, has been on the rise as an alternative to the internal combustion engine. The electric vehicle is a non-polluting vehicle causing no exhaust gas or noise. However, the electric vehicle has not been commercialized due to high production costs, low maximum speed, and short range.

In recent years, in consideration of a high oil price and strengthened exhaust gas regulations, development of the electric vehicle has been accelerated and market therefor is rapidly growing.

### DISCLOSURE

### Technical Problem

Therefore, the present invention has been made in view of the above problems, and it is an object of the present invention to provide a motor vehicle in which a battery is mounted to a vehicle body in an efficient manner.

It is another object of the present invention to provide a motor vehicle which can ensure easy drainage.

Objects of the present invention are not limited to the above described objects, and those skilled in the art will clearly understand other not mentioned objects from the following description.

### Technical Solution

In accordance with one aspect of the present invention, the above and other objects can be accomplished by the provision of a motor vehicle including a battery module configured to supply electric current, a tunnel having an upwardly protruding portion such that the battery module is fitted into the tunnel, a front floor coupled to either side of the tunnel to define a front bottom region, and a battery carrier coupled to both edge portions of the tunnel and configured to support the battery module.

Detailed configurations of other embodiments are included in the following description and the accompanying drawings.

### Advantageous Effects

A motor vehicle according to the present invention has one or more effects as follows.

Firstly, a rear floor extension is provided with a carrier mount, into which a battery carrier is fitted, which may ensure stable installation of a battery module.

Secondly, as the battery carrier is coupled to the rear floor extension to construct a box-shaped section, it is possible to effectively resist broadside collision.

Thirdly, the battery carrier is directly coupled to both edge portions of a tunnel, thereby being capable of absorbing shock generated upon head-on collision.

Fourthly, the tunnel is provided with a reinforcing plate, which may achieve increased strength.

Fifthly, a front floor is coupled to the tunnel with a space defined therebetween, which may result in a simplified configuration.

Sixthly, the floor of a vehicle body may achieve drainage of water without a separate structure.

Seventhly, water present on the floor may be efficiently drained.

Effects of the present invention are not limited to the above described effects, and those skilled in the art will clearly understand other not mentioned effects from the description of the accompanying claims.

### DESCRIPTION OF DRAWINGS

FIG. 1 is a schematic view illustrating a vehicle body according to an embodiment of the present invention;

FIGS. 2 and 3 are partial exploded perspective views illustrating a motor vehicle according to the embodiment of the present invention;

FIG. 4 is a front sectional view illustrating a partial configuration of the motor vehicle according to the embodiment of the present invention;

FIG. 5 is a partial detailed view of the front sectional view of FIG. 4;

FIG. 6 is a perspective view illustrating a rear body part of the motor vehicle according to the embodiment of the present invention;

FIG. 7 is a bottom view of the rear body part of the motor vehicle according to the embodiment of the present invention;

FIG. 8 is a front sectional view illustrating a rear floor extension of the motor vehicle according to the embodiment of the present invention;

FIG. 9 is a partial sectional view illustrating a central body part of the motor vehicle according to the embodiment of the present invention; and

FIG. 10 is a partial perspective view of the motor vehicle according to the embodiment of the present invention.

### BEST MODE

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these example embodiments are provided so that this disclosure will be through and complete and will fully convey the scope to those skilled in the art. The scope of the present invention should be defined by the claims. Wherever possible, the same reference numbers will be used throughout the drawings to refer to the same or like parts.

Hereinafter, the exemplary embodiments of the present invention will be described with reference to the accompanying drawings.

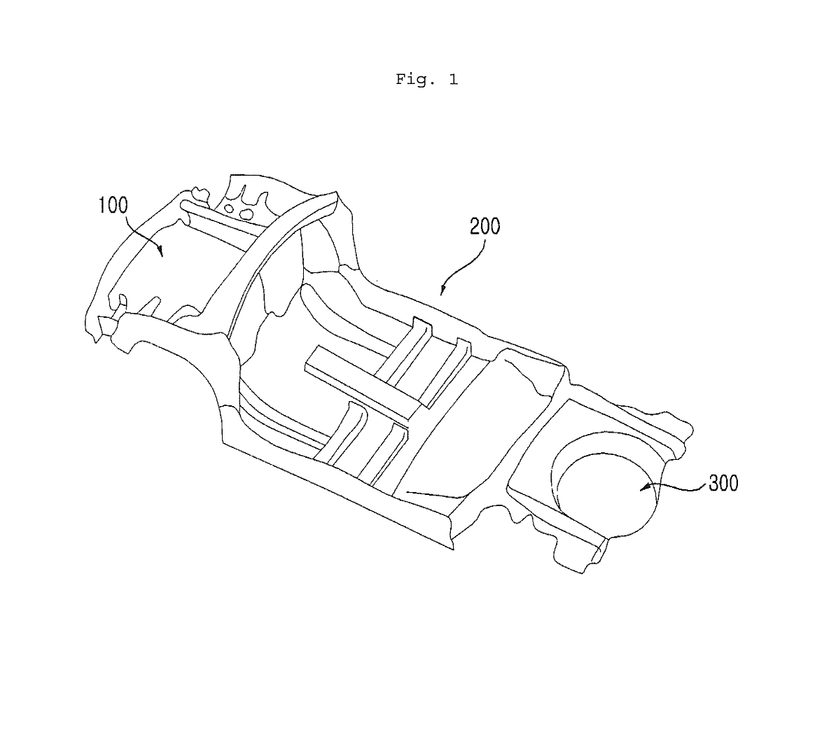

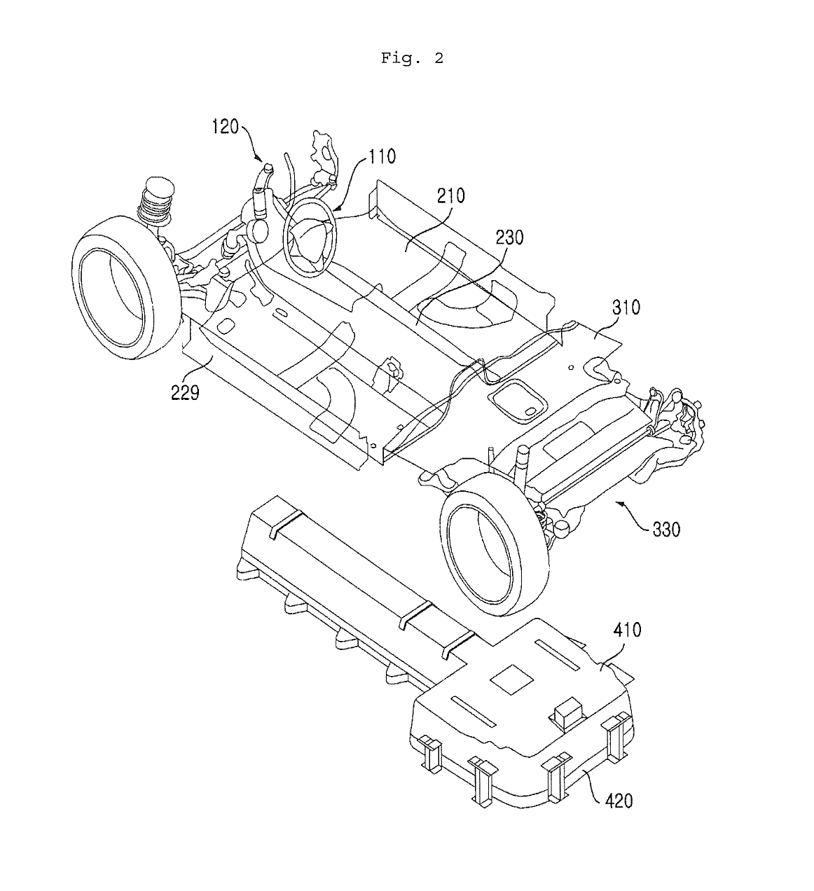

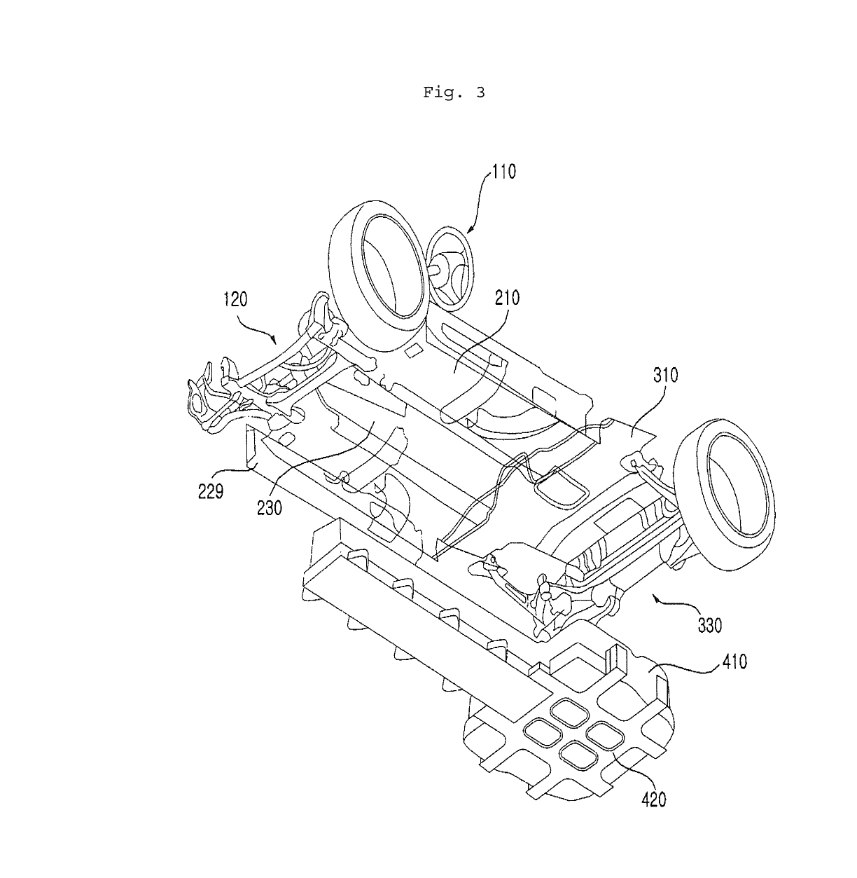

FIG. 1 is a schematic view illustrating a vehicle body according to an embodiment of the present invention, and FIGS. 2 and 3 are partial exploded perspective views illustrating a motor vehicle according to the embodiment of the present invention.

The motor vehicle according to the embodiment of the present invention includes a vehicle body consisting of a front body part 100, to which a motor and power transmission elements are mounted, a central body part 200, in which passengers ride and sit, and a rear body part 300, which is configured to accommodate a spare tire and other objects.

The vehicle body defines a closed space in which a variety of devices is arranged and passengers and freight are accommodated. As necessary, a part of the vehicle body may be opened or closed to ensure easy entrance/exit of the passengers and the freight and easy maintenance and repair of the variety of devices. Another important role of the vehicle body is to protect the passengers and the freight as well as the variety of devices from environmental factors, such as rain, wind, dust and the like. Also, the vehicle body defines the external appearance of the motor vehicle.

The front body part 100 has a “#”-shaped form, and is provided with a motor and a transmission. The front body part 100 is also provided with a steering device 110 and a front wheel suspension device 120. The steering device 100 serves to adjust the orientation of a rotating axle of front wheels to change a movement direction of the motor vehicle. The front wheel suspension device 120 serves to prevent vibration on the road from being directly transmitted to the vehicle body.

Most heavy vehicular elements, such as the motor, the transmission, the variety of auxiliary devices, and the like, are mounted on the front body part 100. The front body part 100 is also necessary to support the front wheels of the front wheel suspension device 120. In addition, in the case of a front wheel drive vehicle, generation of drive force is realized at the front body part 100.

The front body part 100 is configured so as to crumple when strong shock is applied to the front body part 100 upon, for example, accidents. This allows the front body part 100 to absorb the shock, thereby preventing the shock from being transmitted to a vehicle compartment. The respective elements on the front body part 100 may be fastened using bolts or nuts, or may be welded, such that only external elements, such as a front fender and a hood, are separable.

The steering device 110 serves to adjust the orientation of the rotating axle of the front wheels in order to travel the motor vehicle in a direction selected by a driver.

The front wheel suspension device 120 serves to support the front wheels with respect to the vehicle body. The front wheel suspension device supports the front wheels in a vertical direction by springs and other shock-alleviating elements, and in directions except for the vertical direction by the appropriate strength thereof.

The central body part 200 includes a front floor 210 defining a front bottom region of the vehicle body, a tunnel 230 defined at the center of the front floor such that a battery module 410 is fitted into the tunnel, and side seal panels 229 provided at both sides of the front floor to define lower lateral walls.

In most cases, the central body part 200 defines the vehicle compartment in which the passengers ride, and thus may be configured to provide an inner space that is as large as possible.

The front floor 210 defines a front bottom region of the vehicle compartment and is formed of a high strength and large area panel. The side seal panels 229 are attached to both sides of the front floor 210 to extend from a front end to a rear end of the front floor 210. The side seal panel 229 forms a base of each filler. The front floor 210 is centrally provided with the tunnel 230.

The tunnel 230 is upwardly protruded such that the battery module 410 is fitted into the tunnel. Both sides of the tunnel 230 are coupled to the front floor 210. Preferably, the tunnel 230 and the front floor 210 are welded to each other. A battery carrier 420 configured to support the battery module 410 is coupled to both lower edges of the tunnel 230. The battery carrier 420 is fastened to the tunnel 230 using bolts or nuts.

The side seal panels 229 have a rectangular cross section. A front filler (not shown), a center filler (not shown), and a rear wheel house (not shown) may be coupled to the side seal panels 229. The side seal panels 229 are respectively coupled to both sides of the front floor 210.

The rear body part 300 includes a rear floor 310 defining a rear bottom region of the vehicle body. The rear body 300 is provided with a rear wheel suspension device 330 so as to prevent vibration on the road from being directly transmitted to the vehicle body.

The rear body part 300 may be configured to support rear wheels of the rear wheel suspension device 330. In a rear wheel drive vehicle, generation of drive force is realized at the rear body part 300.

The rear wheel suspension device 330 serves to support the rear wheels with respect to the vehicle body. The rear wheel suspension device supports the rear wheels in a vertical direction by springs and other shock-alleviating elements, and in directions except for the vertical direction by the appropriate strength thereof.

The battery module 410 serves to supply electric current. The battery module 410 is an assembly of a plurality of lithium ion cells connected to one another. The battery module 410 has a “T”-shaped form. Preferably, the battery module is mounted to the tunnel 230 of the central body part 200 and the rear floor 310 of the rear body part 300.

The battery carrier 420 supports a battery. The battery carrier 420 is preferably fastened to the central body part 200 and the rear body part 300 using bolts or nuts.

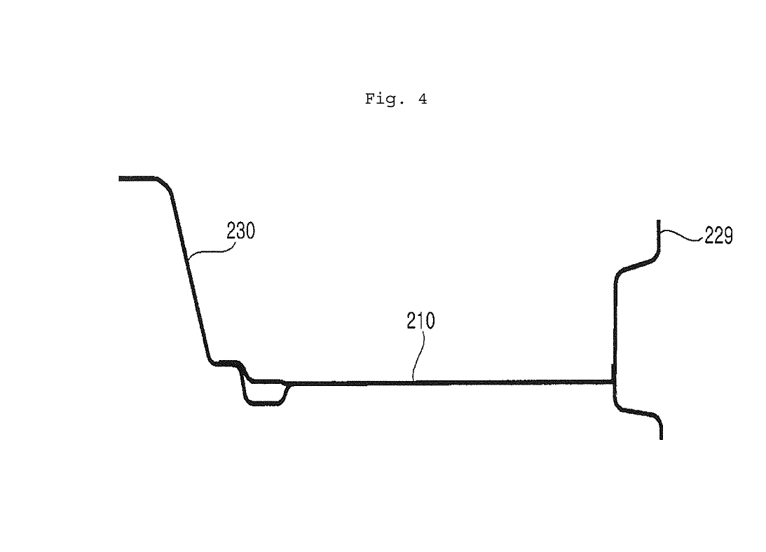

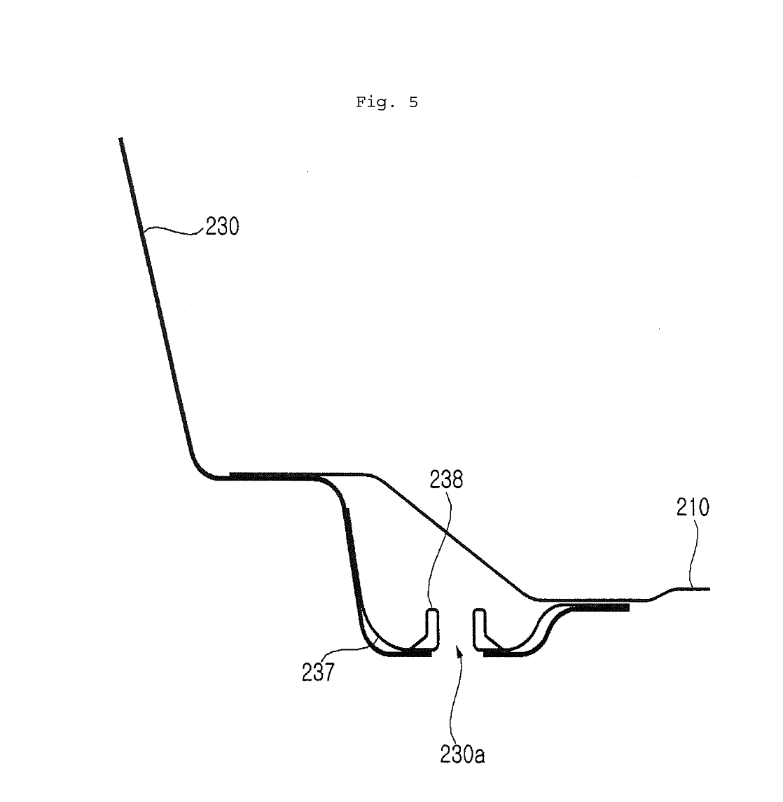

FIG. 4 is a front sectional view illustrating a partial configuration of the motor vehicle according to the embodiment of the present invention, and FIG. 5 is a partial detailed view of the front sectional view of FIG. 4.

The motor vehicle according to the embodiment of the present invention includes the tunnel 230 that is upwardly protruded such that the battery module 410 is fitted into the tunnel, the front floor 210 coupled to either side of the tunnel, and the side seal panels 229 coupled to both sides of the front floor.

The tunnel 230 is provided at an edge portion thereof with mount holes 230a, into which bolts are inserted to fasten the battery carrier 420 to the tunnel. An edge portion of the tunnel 230 in which the mount holes 230a are formed, as shown in FIG. 5, has a downwardly indented “U”-shaped form, which comes into contact with the battery carrier 420. That is, the edge of the tunnel 230 is bent to have a “U”-shaped form, and the mount holes 230a are formed in a flat portion of the “U”-shaped edge portion.

The front floor 210 is welded to the tunnel 230 so as to cover either edge of the tunnel 230. Specifically, the front floor 210 is coupled to the tunnel 230 to cover the “U”-shaped edge portion of the tunnel such that a space is defined between the front floor 210 and the edge portion of the tunnel 230.

With the above described configuration, owing to coupling the front floor 210 to the tunnel 230 so as to cover the edge portion of the tunnel with a space therebetween, the central body part can absorb shock generated upon head-on collision, and the space between the front floor and the tunnel can serve to protect the battery carrier 420 from broadside collision.

Additionally, with relation to coupling the battery carrier 420 to the tunnel, the space between the front floor and the tunnel can provide a space into which the bolts inserted through the mount holes 230a are accommodated. Also, the space can prevent moisture or impurities from entering the vehicle body through the mount holes 230a.

In alternative embodiments, the edge portion of the tunnel 230 and the front floor 210 may be configured in various other ways so long as they can define a space therebetween and can be coupled to each other. In one example, the front floor 210 may be bent to have a “U”-shaped form, and the edge portion of the tunnel 230 may be coupled to cover the front floor 210. In this case, it is preferable that the “U”-shaped bent edge portion of the front floor 210 be provided with the mount holes 230a.

The tunnel 230 is provided with a front carrier mount 238, to which the bolt having passed through the mount hole 230a is fastened. The front carrier mount 238 is located at the mount hole 230a formed in the edge portion of the tunnel 230. The front carrier mount 238 is formed at the “U”-shaped bent edge portion of the tunnel 230 at a position within the range of the front floor 210.

A reinforcing plate 237 may be coupled to the front carrier mount 238 and the tunnel 230 and may serve to increase strength of the tunnel 230 and support the front carrier mount 238. As shown in FIG. 5, the reinforcing plate 237 is preferably stacked on the tunnel 230 in the space defined between the front floor 210 and the tunnel 230 such that the front carrier mount 238 is coupled to an upper surface of the reinforcing plate 237.

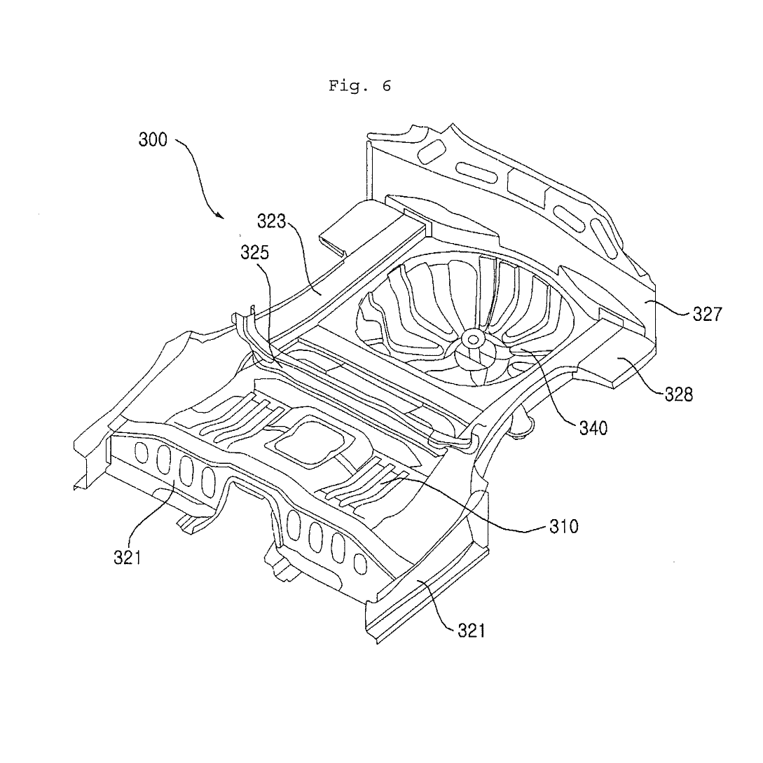

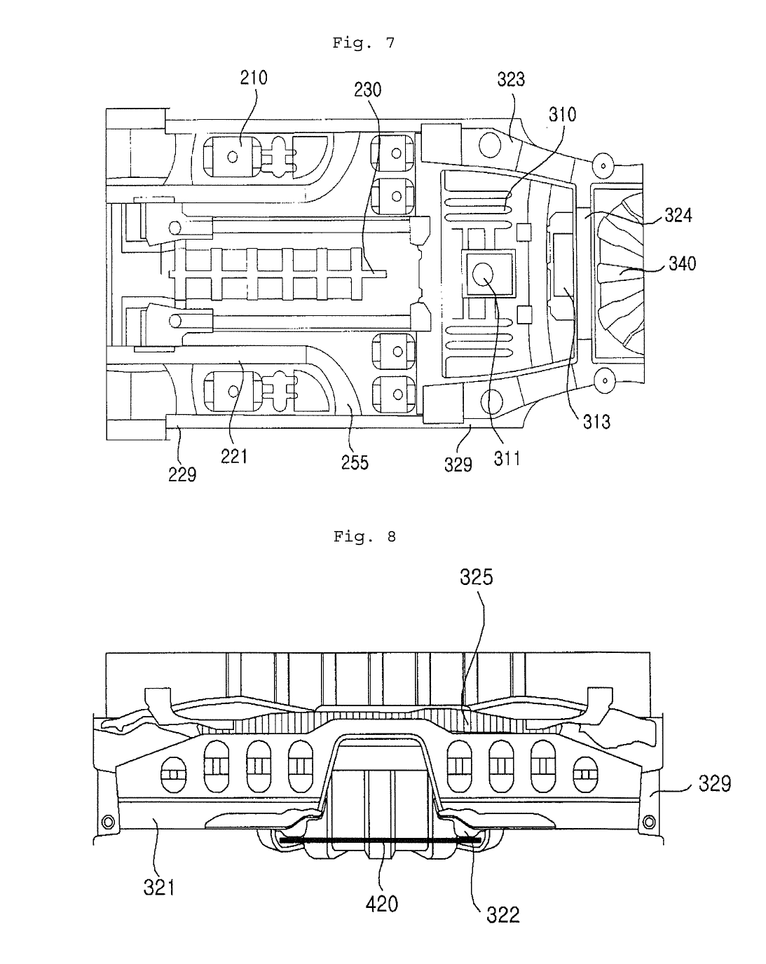

FIG. 6 is a perspective view illustrating the rear body part of the motor vehicle according to the embodiment of the present invention, and FIG. 7 is a bottom view of the rear body part of the motor vehicle according to the embodiment of the present invention.

The motor vehicle according to the embodiment of the present invention includes the rear floor 310 defining a rear bottom region of the vehicle body, to which the battery module 410 is mounted, rear side members 323 which are coupled respectively to both lateral edges of the rear floor to absorb front-and-rear shock, and the battery carrier 420 which is configured to support the battery module and is coupled to the rear side member.

The rear floor 310 defines a rear bottom region of the vehicle compartment as described above. The rear floor 310 defining the bottom of the vehicle compartment is formed of a high strength and large area panel. A rear seat (not shown), in which the passengers sit, may be mounted on the rear floor 310.

The rear floor 310 may define a freight compartment along with a back panel 327. The rear floor 310 defines the bottom of the freight compartment in which freight is stored, and therefore is preferably provided with a spare tire seating portion 340 for accommodating a spare tire.

The battery module 410 is mounted below the rear floor 310. A front portion of the battery module 410 is fitted into the tunnel 230, and a rear portion of the battery module is mounted to the rear floor 310. The battery module 410 is mounted to a portion of the rear floor 310 in front of the spare tire seating portion 340. The battery module 410 may be mounted to a portion of the rear floor 310 in front of a rear cross member 324.

The rear side members 323 are coupled to both sides of the rear floor 310 to extend in a front-and-rear direction. The rear side members 323 serve to absorb shock applied in a front-and-rear direction, thereby preventing distortion and bending of the vehicle body. The battery module 410 is mounted between the rear side members 323.

Preferably, the rear side members 323 are directly coupled to the battery carrier 420 without additional elements, such as brackets, and the like. A lower end of each rear side member 323 may be welded to the battery carrier, or may be fastened using bolts or nuts to the battery carrier. The battery carrier 420 may be fastened to both lower edges of the tunnel 230 using bolts or nuts.

The rear cross member 324 is placed at a lower surface of the rear floor 310. The rear cross member 324 is coupled between the rear side members 323. The rear cross member 324 serves to disperse shock applied to the rear side members 323, thereby preventing distortion and bending of the vehicle body. Preferably, the rear cross member 324 is located at the rearmost possible position to ensure a space for installation of the battery module 410.

A reinforcing cross member 325 is placed on the rear floor 310. The reinforcing cross member 325 is coupled between the rear side members 323. The reinforcing cross member 325 serves to disperse shock applied to the rear side members 323 along with the rear cross member 324, thereby preventing distortion and bending of the vehicle body. The reinforcing cross member 325 is preferably located at a position forward of the rear cross member 324.

Rear side seal panels 329 may be extended from the side seal panels 229, or may be separately provided and be connected to the reinforcing cross member 325 and the side seal panels 229. The rear side seal panels 329 define lower lateral walls, and a variety of fillers may be coupled to the rear side seal panels.

The back panel 327 is coupled to a rear end of the rear floor 310. The back panel 327 defines a rear wall of the freight compartment and prevents distortion of the vehicle body.

A reinforcing plate 328 is coupled to each of the rear side members 323. The rear wheel suspension device 330 is coupled to the reinforcing plate 328. The reinforcing plate 328 is formed of a rigid material to secure the rear wheel suspension device 330 and is firmly coupled to the rear side member 323.

A rear floor extension 321 is used to connect the rear floor 310 and the front floor 210 having different heights. The rear floor 310 is located higher than the front floor 210, and therefore the inclined rear floor extension 321 connects the rear floor 310 and the front floor 210 to each other.

The rear floor extension 321 is provided at both sides thereof with the rear side seal panels 329. A central portion of the rear floor extension 321 is preferably upwardly protruded to correspond to the tunnel 230 such that the battery module 410 is fitted into the rear floor extension 321.

FIG. 8 is a front sectional view illustrating the rear floor extension of the motor vehicle according to the embodiment of the present invention.

The rear floor extension 321 is coupled to the battery carrier 420. The battery carrier 420 is coupled to both lower edges of the upwardly protruding portion of the rear floor extension 321. The rear floor extension 321 and the battery carrier 420 are coupled to define a box-shaped section, which may effectively resist broadside collision. That is, upon broadside collision, shock is distributed to the protruding portion of the rear floor extension 321 and the battery carrier.

In the present embodiment, although the battery carrier 420 configures the box-shaped section along with the protruding portion of the rear floor extension 321, a separate member may be coupled to the edge of the protruding portion of the rear floor extension 321 so as to form a box-shaped section.

The rear floor extension 321 is preferably provided with rear carrier mounts 322 such that the battery carrier 420 is coupled to the rear carrier mounts 322. The battery carrier 420 may be bolted to the rear carrier mounts 322. The rear carrier mounts 322 may be coupled respectively to both lower edges of the protruding portion of the rear floor extension 321.

The rear carrier mount 322 has a downwardly indented “U”-shaped form to correspond to the “U”-shaped bent portion of the above described tunnel 230, and is coupled to the battery carrier 420. Bolts are fastened into the rear carrier mounts 322 to fasten the battery carrier 420 to the rear carrier mounts.

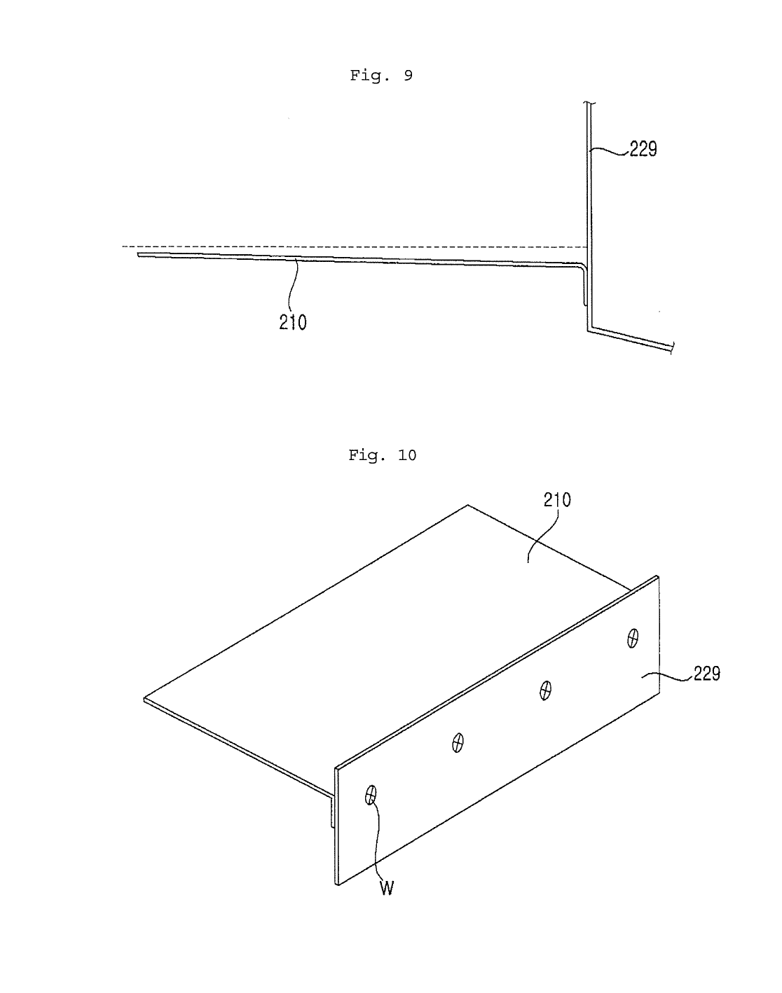

FIG. 9 is a partial sectional view illustrating the central body part of the motor vehicle according to the embodiment of the present invention, and FIG. 10 is a partial perspective view of the motor vehicle according to the embodiment of the present invention.

The motor vehicle according to the embodiment of the present invention includes the upwardly protruding tunnel 230 into which the battery module 410 is fitted, a front floor 210 which is connected to either side of the tunnel and is inclined downward away from the tunnel, and the side seal panel 229 coupled to both sides of the front floor.

The front floor 210 is inclined such that one end of the front floor 210 toward the side seal panel 229 is located lower than the other end of the front floor toward the tunnel 230. With this configuration, water present on the front floor 210 is directed to the side seal panel 229.

A distal end of the front floor 210 is bent downward such that a bent end surface is bonded to the side seal panel 229 via point welding. Since this welding is partially performed, water leakage may occur at not-welded regions. To facilitate drainage of water, drain holes may be formed in a bonded portion of the front floor 210 and the side seal panel 229.

The above described configuration may be applied to the rear floor 310 and other floors as well as the front floor 210.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. A motor vehicle comprising:
a battery module configured to supply electric current;
a tunnel having an upwardly protruding portion such that the battery module is fitted into the tunnel;
a front floor coupled to either side of the tunnel to define a front bottom region; and
a battery carrier coupled to both edge portions of the tunnel and configured to support the battery module.

2. The motor vehicle according to claim 1,
wherein each edge portion of the tunnel has a downwardly indented “U”-shaped form, and
wherein the front floor is coupled to the tunnel so as to cover the “U”-shaped edge portion of the tunnel.

3. The motor vehicle according to claim 2, wherein the tunnel is provided at both edge portions thereof with mount holes, into which bolts are inserted to couple the battery carrier to the tunnel.

4. The motor vehicle according to claim 2, further comprising front carrier mounts provided respectively at both edges of the tunnel, to which bolts are fastened to couple the battery carrier to the tunnel.

5. The motor vehicle according to claim 4, further comprising a reinforcing plate coupled to either edge of the tunnel and coupled to the corresponding front carrier mount.

6. The motor vehicle according to claim 1, further comprising:
a rear floor defining a rear bottom region, the battery module being mounted to a lower surface of the rear floor; and
a rear floor extension configured to connect the front floor and the rear floor to each other, and having an upwardly protruding central portion corresponding to the tunnel such that the battery carrier is coupled to the rear floor extension.

7. The motor vehicle according to claim 6, wherein the battery carrier is coupled to both edges of the protruding portion of the rear floor extension.

8. The motor vehicle according to claim 7, further comprising a rear carrier mount provided at either edge of the protruding portion of the rear floor extension such that the battery carrier is coupled to the rear carrier mount.

9. The motor vehicle according to claim 1, further comprising a rear side member coupled to either side of the rear floor to extend in a front-and-rear direction, the rear side member also being coupled to the battery carrier.

10. The motor vehicle according to claim 1, wherein the front panel is inclined downward away from the tunnel.

11. The motor vehicle according to claim 10, further comprising a side seal panel coupled to either side of the front floor,
wherein the front floor has a downwardly bent end surface bonded to the side seal panel.
